(19) United States
(12) Patent Application Publication
(10) Pub. No.: US 2026/0219947 A1
(43) Pub. Date: Jul. 30, 2026

(54) system and method for classifying computing nodes of a computing network

(71) Applicant: Bank of America Corporation, Charlotte, NC (US)

(72) Inventors: Jemlin Lucas, Coppell, TX (US); Suryanarayana Adivi, Hyderabad (IN); Pushkar Taneja, Hyderabad (IN); Sujatha Ambati, Hyderabad (IN); Niroop Reddy Patimeedi, Hyderabad (IN)

(21) Appl. No.: 19/037,118

(22) Filed: Jan. 25, 2025

(51) Int. Cl. G06F 9/50

(52) U.S. Cl. CPC G06F 9/5038

(57) ABSTRACT

In response to determining that a real-time latency associated with performing a process workflow in a computing network equals or exceeds a threshold, an artificial intelligence (AI) model determines a sequence of tasks associated with the process workflow, determines a server of the computing network that can perform each identified task, and establishes a server group including the identified servers. The server group is configured to perform the process workflow. Upon receiving a subsequent request, the process workflow is performed based on the configuration of the server group.

### TECHNICAL FIELD

The present disclosure relates generally to computer networks, and more specifically to a system and method for classifying computing nodes of a computing network.

### BACKGROUND

In conventional computing networks, after completing a task associated with a process workflow, the system needs to identify what next task is to be performed as part of the process workflow and which computing node (e.g., server) is configured to perform the identified next task. This increases the latency associated with performing each task and the overall process workflow, thus slowing down execution of the process workflow. The latency associated with executing the process workflow is worse when the number of tasks included in the process workflow is greater.

### SUMMARY

The system and method implemented by the system as disclosed in the present disclosure provide technical solutions to the technical problems discussed above by proactively designating computing nodes (e.g., servers) of a computing network that are configured to perform particular tasks in a process workflow.

Computing nodes of a computing network are typically configured to perform several processes depending on the particular use case. A process typically includes a process workflow consisting of a plurality of distinct tasks that need to be performed in a sequence to complete the process. Often, dedicated computing nodes (e.g., servers) are designated to execute certain tasks. Tasks may be assigned to dedicated computing nodes for several reasons. For example, distributing tasks across multiple servers helps to balance the processing load across servers of a computing network. This ensures no single server is overwhelmed, improving overall performance and preventing bottlenecks. By assigning different tasks to dedicated servers, the system can handle a higher volume of work and improve throughput. Other reasons for assigning dedicated servers to perform different tasks include, but are not limited to, resource optimization, ability to run multiple tasks in parallel, fault isolation, and data security.

In conventional computing networks, after completing a task associated with a process workflow, the system needs to identify what next task is to be performed as part of the process workflow and which computing node (e.g., server) is configured to perform the identified next task. This increases the latency associated with performing each task and the overall process workflow, thus slowing down execution of the process workflow. The latency associated with executing the process workflow is worse when the number of tasks included in the process workflow is greater. Slower processing of tasks and process workflows by servers in a computing network can have several negative effects on both server performance and the overall network performance. For example, when each task in a sequence of tasks of a process workflow takes longer to complete due to high latency, the total time required to finish the entire sequence of tasks increases. This directly affects the network's ability to process and transfer data efficiently, leading to slower overall system performance. Higher latency reduces throughput, which is the amount of data transmitted across the network in a given time period. This occurs because each task takes longer to complete, resulting in fewer tasks being processed in the same amount of time. Higher latency associated with performing tasks also results in inefficient use of computing resources in the network. For example, high latency can lead to inefficient use of both server and network resources. For instance, when high latency delays task execution, systems may remain idle while waiting for responses, leading to poor utilization of resources like CPU, memory, and bandwidth. In addition, when tasks with high latency stack up or accumulate due to delays, they can create queues at intermediate network devices like routers, switches, and firewalls. This results in congestion of the network devices thus lowering performance of these devices. Also, when latency increases, applications and servers may be forced to wait longer for responses from external systems or databases. This added delay can lead to increased load on the system, as tasks back up while waiting for network responses, reducing efficiency and performance of servers in a computing network and the underlying network itself.

Embodiments of the present disclosure provide several practical applications and technical advantages that provide solutions to the problems discussed above in relation to conventional computing systems and networks.

For example, the disclosed system and methods provide the practical application of proactively determining and configuring a server group including designated servers that perform each task in a process workflow. As described in embodiments of the present disclosure, to identify servers that perform particular tasks associated with a process workflow, a process manager employs an AI model that is trained to identify a process workflow associated with a process including identifying tasks (e.g., sequence of tasks) that need to be executed to perform the process workflow and further identify particular servers that can perform each of the tasks in the process workflow. Training data used to train an AI algorithm associated with the AI model may at least include a relation matrix and a dependency matrix. The relation matrix includes information relating to which server of the plurality of servers is capable of performing and/or configured to perform which one or more tasks. The dependency matrix includes information relating to tasks (and corresponding servers that are configured to perform those tasks) that are dependent on each other.

In operation, the process manager inputs real-time overall latency associated with performing a process workflow in the computing network to the trained AI model and executes the AI model. Executing the AI model causes the AI model to compare the real-time overall latency associated with processing the process workflow to a threshold overall latency and determine whether the real-time overall latency equals or exceeds the threshold overall latency. Upon determining that the overall latency associated with performing the process workflow equals or exceeds the threshold overall latency, the AI model initiates a process of determining a server group for processing subsequent requests for the process workflow. Based on the relation matrix, the AI model determines a sequence of tasks that need to be performed as part of executing the process workflow. For each identified task, the AI model, based on the dependency matrix, determines a server that is configured to perform the identified task. AI model then establishes a server group that includes the identified servers and outputs the server group as a result of the AI model.

The process manager configures the server group (output by the AI model) for performing the process workflow. Upon receiving a subsequent request for the process workflow, the process manager invokes the configuration of the server group and causes the tasks in the requested process workflow to be performed by the respective designated servers in the configured server group.

By proactively determining servers that can perform tasks associated with the process workflow and by designating the servers to perform the tasks, the disclosed system and method reduce or avoid delays associated with identifying servers that can perform a next task when executing the process workflow. Reducing or avoiding delays in processing each task of the process workflows reduces overall latency associated with executing the processing workflow in the computing network.

Lowering latency associated with performing a sequence of tasks in a computing network can significantly improve network performance and computing performance in several ways and result in several technical advantages. For example, lower latency means that tasks within a sequence are completed more quickly. This results in faster processing and data exchange across the network. Lower latency increases throughput of the network and computing nodes connected to the network. Since each task in a sequence takes less time to complete, more tasks can be processed in the same amount of time, resulting in higher throughput. With reduced latency, network and server resources are used more efficiently. Servers spend less time waiting for responses from other systems and can focus on processing tasks more rapidly, leading to better resource utilization. Lower latency also reduces the time spent waiting in queues for resources or data. This minimizes the chance of congestion or backlogs at network devices (e.g., routers, switches) or servers. As a result, data flows more freely through the network. In addition, reducing latency helps optimize bandwidth by allowing data to flow more efficiently. When tasks are completed more quickly, less bandwidth is wasted on waiting for data to be acknowledged or retransmitted, and the network can handle higher volumes of traffic.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a system, in accordance with certain aspects of the present disclosure; and

FIG. 2 illustrates a flowchart of an example method for performing a process workflow associated with a process, in accordance with certain embodiments of the present disclosure.

### DETAILED DESCRIPTION

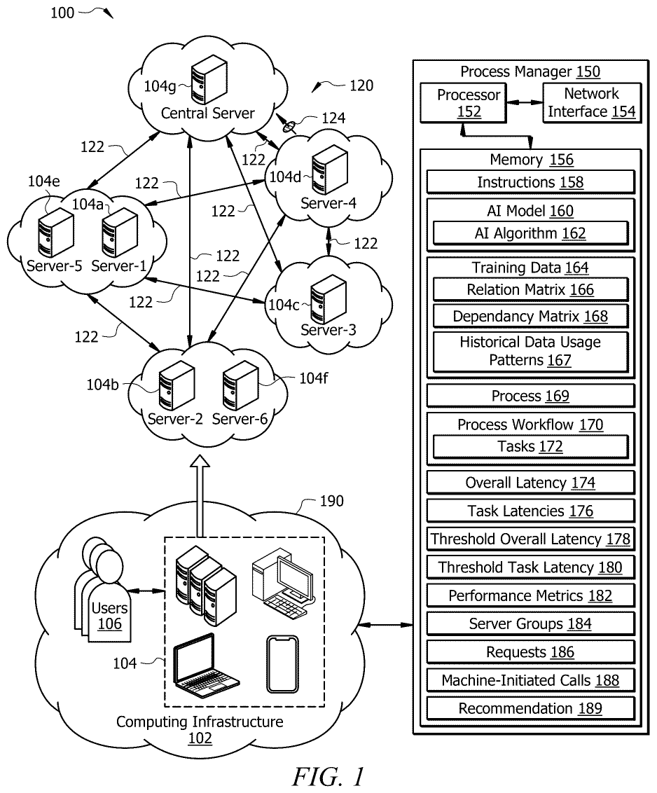

FIG. 1 is a schematic diagram of a system 100, in accordance with certain aspects of the present disclosure. As shown, system 100 includes a computing infrastructure 102 connected to a network 190. Computing infrastructure 102 may include a plurality of hardware and software components. The hardware components may include, but are not limited to, computing nodes 104 such as desktop computers, smartphones, tablet computers, laptop computers, data servers and data centers, mainframe computers, virtual reality (VR) headsets, augmented reality (AR) glasses and other hardware devices such as printers, routers, hubs, switches, and memory all connected to the network 190. Software components may include software applications that are run by one or more of the computing nodes 104 including, but not limited to, operating systems, user interface applications, third party software, database management software, service management software, mainframe software, metaverse software, AI tools and other customized software programs (e.g., process manager 150) implementing particular functionalities. For example, software code relating to one or more software applications may be stored in a memory device and one or more processors (e.g., belonging to one or more computing nodes 104) may execute the software code to implement respective functionalities. An example software application run by one or more computing nodes 104 of the computing infrastructure 102 may include the process manager 150. In one embodiment, at least a portion of the computing infrastructure 102 may be representative of an Information Technology (IT) infrastructure of an organization.

One or more of the computing nodes 104 may be operated by a user 106. In this context, a computing node 104 operated by a user may be referred to as a user device. For example, a computing node 104 may provide a user interface using which a user 106 may operate the computing node 104 to perform data interactions within the computing infrastructure 102. The term “computing node 104” may be replaced by “user device” in this disclosure when the computing node 104 is operated by a user 106.

One or more computing nodes 104 of the computing infrastructure 102 may be representative of a computing system which hosts software applications that may be installed and run locally or may be used to access software applications running on a server. The computing system may include mobile computing systems including smart phones, tablet computers, laptop computers, or any other mobile computing devices or systems capable of running software applications and communicating with other devices. The computing system may also include non-mobile computing devices such as desktop computers or other non-mobile computing devices capable of running software applications and communicating with other devices. In certain embodiments, one or more of the computing nodes 104 may be representative of a server running one or more software applications to implement respective functionality as described below. In certain embodiments, one or more of the computing nodes 104 may run a thin client software application where the processing is directed by the thin client but largely performed by a central entity such as a server (not shown).

Network 190, in general, may be a wide area network (WAN), a personal area network (PAN), a cellular network, or any other technology that allows devices to communicate electronically with other devices. In one or more embodiments, network 190 may be the Internet.

Computing nodes 104 of a computing network such as computing infrastructure 102 are typically configured to perform several processes depending on the particular use case. A process typically includes a process workflow 170 consisting of a plurality of distinct tasks 172 that need to be performed in a sequence to complete the process. Often dedicated computing nodes (e.g., servers) are designated to execute certain tasks. Tasks may be assigned to dedicated computing nodes 104 for several reasons. For example, distributing tasks across multiple servers helps to balance the processing load across servers of a computing network. This ensures no single server is overwhelmed, improving overall performance and preventing bottlenecks. By assigning different tasks to dedicated servers, the system can handle a higher volume of work and improve throughput. Other reasons, for assigning dedicated servers to perform different tasks include, but are not limited to, resource optimization, ability to run multiple tasks in parallel, fault isolation, and data security. In some cases, a single computing node (e.g., server) can be configured to perform two or more tasks, for example, when the server is sufficiently powerful to handle the multiple tasks and/or when the tasks are not resource hungry (e.g., need lower CPU and memory resources, requests for the tasks are low or sporadic etc.).

FIG. 1 illustrates an example computing network 120 that is implemented by a portion of the computing nodes 104 of the computing infrastructure 102. As shown in FIG. 1, computing network 120 includes servers 104a-104g (shown as servers 1-6 and central server 104g). Each of the servers 104a-104g is configured to perform/execute one or more tasks 172. For example, servers 104a (server-1) and 104e (server-5) may be configured to perform an approval task, servers 104b (server-2) and 104f (server-6) may be configured to perform a user authentication task, server 104c (server-3) may be configured to perform a verification task, and server 104d (server-4) may be configured to perform a report generation task. In one example, server 104d may receive a request to generate an employee report for all employes located in a certain geographical region. The request may be a user request or a machine-initiated request. In order to generate the requested employee report, a process workflow 170 may need to be executed that includes performing a plurality (e.g., a sequence) of distinct tasks 172. For example, a first task 172 in the sequence of tasks 172 in the process workflow 170 may include authenticating the identity of the user 106 that requested the employee report. This may include server 104d placing a machine-initiated call 188 to server 104b to authenticate the identity of the requesting user. Upon successful authentication of the user, the next task 172 of the process workflow 170 may include verifying the identified user's authorization to request the employee record. This may include, server 104b placing a machine-initiated call 188 to server 104c to verify the authorization of the user 106 to request the employee report. Upon determining by server 104c that the user 106c is authorized to request the employee report, the next task 172 in the process workflow 170 may include approval to access data relating to generation of the employee report. For example, to generate the requested employee report server 104d may need to access employee records stored at the central server 104g. However, server 104d may need approval to access those employee records. Server 104d may place a machine-initiated call to server 104a to request approval for accessing the employee records. Upon receiving approval from server 104a, server 104d may generate the requested employee report. In one embodiment, computing network 120 is implemented using a distributed cloud environment. In another embodiment, cloud servers from multiple cloud services are used to implement different tasks 172 in the computing network 120. For example, as shown in FIG. 1, servers 104a and 104e, servers 104b and 104f, server 104c, server 104d and central server 104g are implemented using separate cloud services.

In conventional computing networks, after completing a task 172 associated with a process workflow 170, the system needs to identify what next task 172 is to be performed as part of the process workflow 170 and which computing node 104 (e.g., server) is configured to perform the identified next task. This increases the latency associated with performing each task 172 and the overall process workflow 170, thus slowing down execution of the process workflow 170. The latency associated with executing the process workflow 170 is worse when the number of tasks 172 included in the process workflow 170 is greater.

Embodiments of the present disclosure address the technical problems described above with executing process workflows 170 in conventional computing networks (e.g., computing network 120) by providing improved techniques to efficiently execute process workflows 170 thus improving speed of executing the process workflows 170. The described techniques include classifying servers (e.g., servers 104a-g shown in FIG. 1) in a computing network (e.g., computing network 120) based on their capabilities and/or functionalities to perform certain tasks 172. For example, the described techniques include proactively determining and configuring a server group 184 including designated servers that perform each task 172 in a process workflow 170.

At least a portion of the computing infrastructure 102 (e.g., one or more computing nodes 104) may implement a process manager 150 which may be configured to implement techniques for proactively designating computing nodes 104 (e.g., servers 104a-g shown in FIG. 1) to perform certain tasks 172. The process manager 150 includes a processor 152, a memory 156, and a network interface 154. The process manager 150 may be configured as shown in FIG. 1 or in any other suitable configuration.

The processor 152 includes one or more processors operably coupled to the memory 156. The processor 152 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 152 may be a programmable logic device, a microcontroller, a microprocessor, or any suitable combination of the preceding. The processor 152 is communicatively coupled to and in signal communication with the memory 156. The one or more processors are configured to process data and may be implemented in hardware or software. For example, the processor 152 may be 8-bit, 16-bit, 32-bit, 64-bit or of any other suitable architecture. The processor 152 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

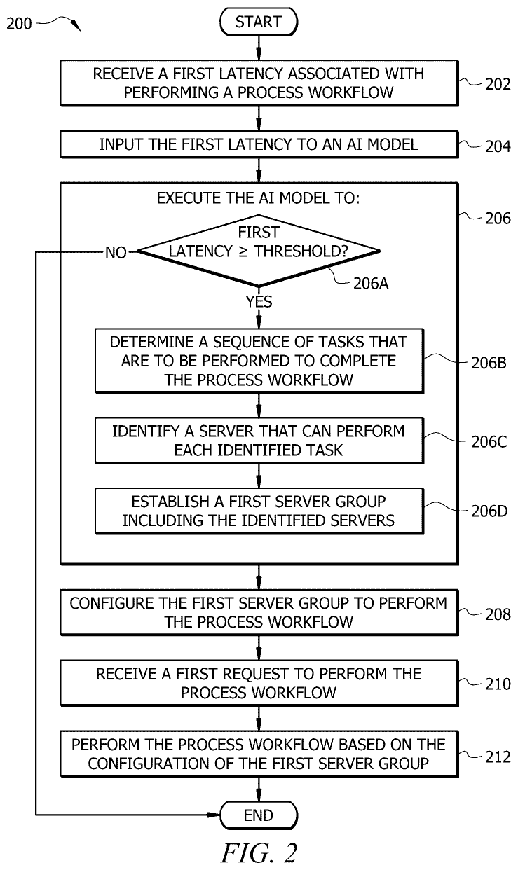

The one or more processors are configured to implement various instructions, such as software instructions. For example, the one or more processors are configured to execute instructions 158 to implement the process manager 150. In this way, processor 152 may be a special-purpose computer designed to implement the functions disclosed herein. In one or more embodiments, the process manager 150 is implemented using logic units, FPGAs, ASICs, DSPs, or any other suitable hardware. The process manager 150 is configured to operate as described with reference to FIGS. 1 and 2. For example, the processor 152 may be configured to perform at least a portion of method 200 as described with reference to FIG. 2 respectively.

The memory 156 includes a non-transitory computer-readable medium such as one or more disks, tape drives, or solid-state drives, and may be used as an over-flow data storage device, to store programs when such programs are selected for execution, and to store instructions and data that are read during program execution. The memory 156 may be volatile or non-volatile and may include a read-only memory (ROM), random-access memory (RAM), ternary content-addressable memory (TCAM), dynamic random-access memory (DRAM), and static random-access memory (SRAM).

The memory 156 is operable to store the instructions 158, Artificial Intelligence (AI) model 160 including respective AI algorithms 162, training data 164 including relation matrix 166, dependency matrix 168 and historical data usage patterns 167, information relating to processes 169, information relating to process workflows 170 associated with the respective processes 169 including information relating to one or more tasks 172 included in each process workflow 170, overall latencies 174 associated with each process workflow 170, individual task latencies 176, threshold overall latency 178, threshold task latency 180, performance metrics 182 associated with computing nodes 104 (e.g., servers 104a-g), server groups 184, requests 186 to perform process workflows 170, machine-initiated calls 188, recommendations 189 and any other data needed to performed operations of the process manager 150 as described in embodiments of the present disclosure. The instructions 158 may include any suitable set of instructions, logic, rules, or code operable to execute the process manager 150.

The network interface 154 is configured to enable wired and/or wireless communications. The network interface 154 is configured to communicate data between the process manager 150 and other devices, systems, or domains (e.g., computing nodes 104 such as servers 104a-g). For example, the network interface 154 may include a Wi-Fi interface, a LAN interface, a WAN interface, a modem, a switch, or a router. The processor 152 is configured to send and receive data using the network interface 154. The network interface 154 may be configured to use any suitable type of communication protocol as would be appreciated by one of ordinary skill in the art.

It may be noted that each of the computing nodes 104 (e.g., servers 104a-g) may be implemented like the process manager 150 shown in FIG. 1. For example, each of the computing nodes 104 may have a respective processor and a memory that stores data and instructions to perform a respective functionality of the computing node 104.

The process manager 150 may be configured to proactively determine one or more servers 104a-g that perform certain tasks 172 in a process workflow 170 associated with a process 169 and configure those determined servers to perform the tasks 172 in the process workflow 170. In one embodiment, to identify servers 104a-g that perform particular tasks 172 associated with a process workflow 170, the process manager 150 employs AI model 160 that is trained to identify a process workflow 170 including identifying tasks 172 (e.g., sequence of tasks 172) that need to be executed to perform a process 169 and further identify particular servers 104a-g that can perform each of the tasks 172 in the process workflow 170.

An artificial intelligence (AI) model (e.g., AI model 160 shown in FIG. 1) is a mathematical framework that learns patterns from data in order to make predictions or decisions without being explicitly programmed for every task. The model is designed to recognize relationships or patterns within the input data (features) and use this learned information to make predictions on new, unseen data. The core idea is that the AI model “learns” from historical data (training data) and generalizes that learning to make accurate predictions on test data or real-world applications. Depending on the task, AI models can be classified into several categories. For example, an AI algorithm associated with a supervised AI model is trained on labeled data (e.g., inputs paired with known outputs) to learn the mapping between inputs and outputs. An AI algorithm associated with an unsupervised AI learning model is trained on unlabeled data to find hidden patterns or groupings (e.g., clustering or dimensionality reduction). A reinforcement AI model learns by interacting with an environment and receiving feedback based on actions taken.

An AI model 160 may rely on various AI algorithms 162 to learn from data (e.g., training data 164) and make predictions, classifications, or decisions. The choice of algorithm depends on the type of task (supervised, unsupervised, reinforcement learning), the nature of the data, and the specific problem being solved. Common AI algorithms used by AI models include, but are not limited to, supervised learning algorithms such as regression and classification algorithms, unsupervised learning algorithms such as clustering algorithms and dimensionality reduction algorithms, reinforcement learning algorithms, ensemble learning algorithms, and deep learning algorithms. As shown in FIG. 1, AI model 160 uses AI algorithm 162. In one embodiment, AI model 160 is a generative AI model.

In one or more embodiments, as shown in FIG. 1, training data 164 used to train AI algorithm 162 associated with the AI model 160 may include one or more of relation matrix 166, dependency matrix 168, or historical data usage patterns 167. Relation matrix 166 includes information relating to which server of the plurality of servers 104a-104g is capable of performing and/or configured to perform which one or more tasks 172. In other words, for each of the servers 104a-g, the relation matrix 166 identifies one or more tasks 172 that the server is configured to perform and/or capable of performing. For example, following the example discussed above, relation matrix 166 may identify that servers 104a (server-1) and 104e (server-5) are configured to perform an approval task, servers 104b (server-2) and 104f (server-6) are configured to perform a user authentication task, server 104c (server-3) is configured to perform a verification task, and server 104d (server-4) is configured to perform a report generation task. Additionally, or alternatively, relation matrix 166 may include information relating to logical connections 122 between pairs of servers 104a-g. A logical connection 122 between two servers refers to a virtual pathway established through network protocols, allowing the servers to communicate with each other, even if they are physically located on different networks, essentially meaning that data can be exchanged between them as if they were directly connected, regardless of the underlying physical network topology or hardware involved. In one embodiment, relation matrix 166 only includes information relating to the logical connections 122 configured between servers 104a-g and the information relating to which server of the plurality of servers 104a-104g is capable of performing and/or configured to perform which one or more tasks 172 is maintained separately in a table (not shown). In this embodiment, the table including the information relating server-task mappings is additionally part of training data 164 and may be used to train the AI algorithm 162 associated with the AI model 160.

Dependency matrix 168 includes information relating to tasks 172 (and corresponding servers that are configured to perform those tasks 172) that are dependent on each other. In this context, dependency of a first server configured to perform a first task to a second server configured to perform a second task means that the first server is dependent on the second server to finish processing the second task before it could process the first task. For example, following the report generation example described above, before initiating generation of a requested employee report, server 104d needs approval to access employee records stored at the central server 104g. This means that the report generation task is dependent on the result of the approval task. According to this example, since the approval task is performed by server 104a, this means that server 104d cannot start the process of report generation until server 104a has finished its approval task and has approved access to the employee records. Similarly, following this example, the report generation task may further be dependent on successful authentication of an identity of the user requesting to generate the report and further upon successfully verifying authorization of the requesting user to request such a report. This means that the report generation task of server 104d is further dependent on the user authentication task performed by server 104b and verification task performed by server 104c. In addition, the verification task may be performed only after the user identity is successfully authenticated. This means that the verification task of server 104c is dependent on the user authentication task performed by server 104b. Further, the approval task of server 104a may be performed only upon successful user authentication and verification. This means that the approval task of server 104a is dependent on the user authentication task performed by server 104b and verification task performed by server 104c. In one embodiment, information relating to these task dependencies and corresponding server dependencies are stored as part of the dependency matrix 168.

In one or more embodiments, AI algorithm 162 may be trained to trigger determination of one or more servers 104a-g for performing respective tasks 172 associated with a process workflow 170 based on one or more real-time performance metrics 182 associated with processing tasks 172 and process workflows 170 by servers of the computing network 120. In this context, process manager 150 may have access to a plurality of real-time performance metrics 182 associated with servers 104a-g of the computing network 120, wherein each performance metric 182 indicates performance of the respective server for to which the performance metric 182 relates. Performance metrics 182 associated with a server 104a-g may include, but are not limited to, central processing unit (CPU) utilization, memory usage, disk input/output (I/O), average processing load, response time, processing latency, or a combination thereof. Additionally, or alternatively, the performance metrics 182 may include real-time overall latencies 174 associated with performing process workflows 170 and real-time task latencies 176 associated with performing individual tasks 172 by respective servers of the computing network 120.

In one embodiment, training data 164 used to train AI algorithm 162 associated with the AI model 160 may include a threshold overall latency 178 and one or more threshold task latencies 180. In this context, AI algorithm 162 associated with AI model 160 may be trained to determine whether the overall latency 174 associated with processing a particular process workflow 170 in the computing network 120 equals or exceeds the threshold overall latency 178. In an additional or alternative embodiment, AI algorithm 162 associated with AI model 160 may be trained to determine whether a task latency 176 associated with processing a particular task 172 by a particular server 104a-g equals or exceeds a respective task latency 176. In one embodiment, customized task latencies 176 may be defined for particular servers of the computing network 120 depending on the processing capabilities of the servers. As described below, the AI model 160 may trigger certain operations (e.g., generation of server group 184) in response to detecting that the overall latency 174 associated with processing a particular process workflow 170 in the computing network 120 equals or exceeds the threshold overall latency 178. Similarly, the AI model 160 may trigger certain operations in response to detecting that a task latency 176 associated with processing a particular task 172 by a particular server 104a-g equals or exceeds a respective task latency 176.

In operation, process manager 150 may be configured to input a plurality of performance metrics 182 to the trained AI model 160. The performance metrics 182 input to the AI model 160 may include one or more of real-time performance metrics 182 measured for individual servers 104a-e, real-time overall latencies 174 associated with processing particular process workflows 170, or real-time task latencies 176 associated with processing individual tasks 172 by particular servers 104a-g. Additionally, or alternatively, process manager 150 may be configured to input information relating to the process workflows 170 associated with the overall latencies 174 and information relating to the tasks 172 relating to the task latencies 176. After inputting the performance metrics 182 and other information to the AI model 160, process manager 150 may execute the AI model 160 with the trained AI algorithm 162. In one embodiment, executing the AI model 160 includes executing the trained AI algorithm 162.

In one embodiment, executing the AI model 160 causes the AI model 160 to first compare the real-time overall latency 174 associated with processing a particular process workflow 170 in the computing network 120 to the threshold overall latency 178 and determine whether the real-time overall latency 174 equals or exceeds the threshold overall latency 178. Following the report generation example discussed above, the performance metrics 182 input to the AI model 160 may include a real-time overall latency 174 associated with processing a requested employee report generation in the computing network 120. The AI model 160 may determine whether the real-time overall latency 174 associated with generating the report equals or exceeds the threshold overall latency 178. In response determining that the real-time overall latency 174 associated with processing the process workflow 170 equals or exceeds the threshold overall latency 178, AI model 160 initiates the process of determining a server group 184 for processing subsequent requests for the process workflow 170 (e.g., employee report generation). As described below, the determined server group 184 includes designated servers 104a-g that perform each task 172 in the process workflow 170.

To determine the server group 184 associated with the process workflow 170 (e.g., employee report generation), AI model 160 first determines one or more tasks 172 that need to be performed to process the process workflow 170 and an order in which those tasks 172 are to be performed (e.g., sequence of the tasks 172) to execute the process workflow 170. In one embodiment, AI model 160 determines the sequence of tasks 172 associated with the process workflow 170 based on the dependency matrix 168. As described above, dependency matrix 168 includes information relating to tasks 172 (and corresponding servers that are configured to perform those tasks 172) that are dependent on each other. In relation to the report generation example described, AI model 160 may determine from the dependency matrix 168 that the report generation task is dependent on the approval task, the user authentication task and the verification task, the verification task is dependent on the user authentication task, and the approval task is dependent on the user authentication and verification tasks. Based on these task dependencies, AI model 160 may determine the tasks 172 needed for performing the report generation process workflow are user authentication, verification, approval and report generation. Further, AI model 160 determines that these tasks need to be performed in the order of user authentication followed by verification followed by approval and finally report generation.

Once the sequence of tasks 172 associated with the process workflow 170 is determined, AI model 160 determines a server 104a-g that can perform each of the identified tasks 172. In one embodiment, AI model 160 determines the servers 104a-g for performing each of the identified tasks 172 based on the relation matrix 166. As described above, the relation matrix 166 includes information relating to which server of the plurality of servers 104a-104g is capable of performing and/or configured to perform which one or more tasks 172. The relation matrix 166 may further include information relating to logical connections 122 between pairs of servers 104a-g. Based on the task-server mapping and the logical connections 122 between servers, AI model 160 may identify a server for performing each of the identified task. In relation to the report generation example, relation matrix 166 may identify that servers 104a (server-1) and 104e (server-5) are configured to perform an approval task, servers 104b (server-2) and 104f (server-6) are configured to perform a user authentication task, server 104c (server-3) is configured to perform a verification task, and server 104d (server-4) is configured to perform a report generation task. Based on these task-server mappings, AI model 160 may select server 104a for performing the approval task, server 104b for performing the user authentication task, server 104c for performing the verification task, and server 104d for performing report generation task. In one embodiment, when multiple servers are indicated as configured to perform a same task 172 in the relation matrix 166, AI model 160 may select one of the servers based on the real-time performance of the servers as indicated by the real-time performance metrics 182 associated with the servers. For example, among servers 104a and 104e configured to perform the approval task, AI model 160 may select server 104a based on detecting that server 104a has a better CPU response time as compared to server 104e.

Once a particular server for performing each of tasks 172 is identified/selected, AI model 160 establishes a server group 184 that includes the identified servers and tasks to be performed by each of the identified servers. In relation to the report generation example, the server group 184 includes server 104a for performing the approval task, server 104b for performing the user authentication task, server 104c for performing the verification task, and server 104d for performing report generation task. In one embodiment, AI model 160 outputs the server group 184 as a result of the AI model 160.

In one or more embodiments, upon obtaining the server group 184 associated with performing the process workflow 170 (e.g., report generation) as a result of the AI model 160, process manager 150 may configure the server group 184 for executing any subsequent requests for performing the process workflow 170. In one embodiment, upon receiving a subsequent request to perform the process workflow 170, the configuration of the server group 184 causes each designated server from the server group 184 to perform the corresponding task 172. For example, after the server group 184 has been configured to perform the process workflow 170 of employee report generation, process manager 150 may receive a request 186 (e.g., user request or machine-initiated request) to perform an employee report generation. In response to receiving the request 186, process manager 150 may access the configuration of the server group 184 and initiate the execution of the process workflow 170 based on this configuration. For example, as a first step of executing the report generation workflow, process manager 150, based on the configuration, may issue a machine-initiated call 188 to server 104b to authenticate the identity of the user. Once the identity of the user is successfully authenticated, process manager 150, based on the configuration, may issue another machine-initiated call 188 to server 104c to verify authorization of the requesting user to request the report generation. Once the authorization of the user is successfully verified, process manager 150, based on the configuration, may issue another machine-initiated call 188 to server 104a to approve access of server 104d to employee records stored at the central server 104g. Upon approval, process manager 150, based on the configuration, may issue another machine-initiated call 188 to server 104d to generate the requested report.

In one or more additional or alternative embodiments, executing the AI model 160 may cause the AI model 160 to compare real-time task latencies 176 of the individual servers 104a-g with corresponding threshold task latencies 180 and determine whether a task latency 176 associated with a particular server equals or exceeds the corresponding threshold task latency 180 pre-selected for that server. For example, based on the comparison of individual task latencies 176 associated with particular servers with the corresponding threshold task latencies 180, AI model 160 may determine that the task latency 176 associated with processing approval task by server 104a exceeds the threshold task latency 180 configured for server 104a. In response to detecting that the task latency 176 associated with a particular server equals or exceeds the corresponding threshold task latency 180 pre-selected for that server, AI model 160 determines that the server has experienced an anomaly. For example, when the task latency 176 associated with a particular server equals or exceeds the corresponding threshold task latency 180 pre-selected for that server, it indicates that the server is taking longer than normal to process the task, which in turn indicates that the server is not operating normally. In response to determining that the server has experienced an anomaly, AI model 160 identifies (e.g., based on the relation matrix 166) an alternative server that is configured to perform the same task and configures the alternative server to perform the task upon subsequent requests for the task. When the original server that is determined to have experienced an anomaly is part of a server group 184 associated with a process workflow 170, AI model 160 establishes a second server group 184 by replacing the original server from the original server group 184 with the alternative server. Any subsequent requests for performing the process workflow 170 are executed based on the second server group 184 instead of the original server group. For example, upon detecting that server 104a configured to perform the approval task is experiencing an anomaly, AI model 160 may identify from the relation matrix 166 that server 104e is also configured to perform the approval task and may configure server 104e to perform the approval task.

In one or more additional or alternative embodiments, executing the AI model 160 may cause the AI model 160 to determine whether a particular server 104a-g is overloaded. For example, based on the real-time performance metrics 182 associated with a particular server 104a, AI model 160 may determine that server 104a is overloaded. For example, AI model 160 may detect that the memory utilization and CPU utilization of server 104a exceed respective thresholds and, in response, determine that server 104a is overloaded. Upon determining that server 104a is overloaded, AI model 160 identifies (e.g., based on the relation matrix 166) an additional server 104e that is also configured to perform the same task (e.g., approval task). Upon identifying the additional server 104e, AI model 160 establishes a second server group 184 by replacing the first original server 104a from the original server group 184 with the server 104e. Process manager 150 configures the second server group 184, in addition to the first original server group, to perform the process workflow 170 (e.g., report generation). Once the two server groups are configured for the process workflow 170, to reduce processing load from server 104a, process manager 150 configures the original first server group to execute a first portion of requests (e.g., a first percentage of requests) for the process workflow and configures the second server group to execute a remaining second portion of the requests (e.g., second percentage of requests) for the process workflow 170. This divides the workload between servers 104a and 104e, thus reducing the workload on server 104a and improving performance of the server 104a.

In one or more additional or alternative embodiments, process manager 150 may be configured to generate recommendations 189 to transfer data between servers 104a-g of the computing network 120 based on historical data usage patterns 167 associated with the computing network 120. The AI algorithm 162 may be trained based on historical data usage patterns 162 associated with the computing network 120, to determine recommendations for transferring data between servers 104a-g of the computing network 120. The historical data usage patterns 167 refer to patterns/trends of how particular pieces of data are used in the computing network 120. For example, a particular historical data usage pattern 167 may indicate a repetitive usage pattern associated with a particular piece of data 124. For example, the repetitive usage pattern may indicate that demand (e.g., requests) for the particular piece of data 124 significantly increases (e.g., demand equals or exceeds a threshold demand) during certain time periods (e.g., certain time ranges in a day, certain days of the week, certain time of a month, quarterly, yearly etc.). For example, a large multi-national organization that has employees in several countries may mandate that employee reports are generated for every region on the last day of each quarter of a year. This means that a plurality of servers across several regions may place simultaneous or near simultaneous requests at the end of each quarter for the report generation task performed by server 104d. This means that demand for a report generation software running at server 104d significantly increases (e.g., demand equals or exceeds a threshold demand) on the last day of each quarter. In this example, the piece of data 124 is the report generation software stored at server 104d and the historical data usage pattern 167 associated with the piece of data 124 is the repetitive pattern of increase in demand for the report generation software on the last day of each quarter.

In some cases, server 104d may not be sufficiently powerful to handle the increased demand for the piece of data 124. For example, server 104d may be configured to handle normal demand for the report generation task but may not have sufficient processing power and/or memory resources to handle the increased demand. In this case, the trained AI model 160 may be configured to identify the periodic increase (e.g., quarterly increase) in demand for the piece of data 124 (e.g., report generation software) based on the historical data usage pattern 167 associated with the piece of data 124. In response to identifying the periodic increase in demand, AI model 160 may predict that demand for the piece of data is to increase at a future time (e.g., last day of next quarter). Additionally, AI model 160 may identify that based on the relation matrix that the piece of data 124 is stored at server 104d. For example, based in the relation matrix, AI model may identify that server 104d handles the report generation task and that the report generation software is stored at server 104d. Further, based on the performance metrics 182 associated with server 104d, AI model 160 may determine that server 104d is not capable to handle the increased load (e.g., increased requests) associated with the piece of data 124. In this context, the performance metrics 182 may include hardware/software configuration of server 104d, real-time performance metrics as described above, or a combination thereof. For example, based on the performance metrics 182 associated with server 104d, AI model 160 may determine that server 104d is not capable to process the increased quarterly requests for report generation received by a plurality of regional servers in the computing network 120. In response to the predicted increase in demand for the piece of data 124 at a predicted later time (e.g., last day of next quarter) and determining that server 104d cannot process the increased demand, AI model 160 may identify, based on the relation matrix 166, another server that is faster than server 104d and can handle the increased demand for the piece of data 124. In other words, AI model 160 identifies another server that has sufficient processing capabilities to process the increased requests for the piece of data 124. For example, based on the relation matrix 166, AI model 160 identifies that central server 104g has sufficient processing capability to handle the increased requests for report generation on the last day of next quarter. In an alternative or additional embodiment, AI model 160 may determine that processing capability of central server 104g based on performance metrics 182 associated with the central server 104 including hardware/software configuration of central server 104g and/or real-time performance metrics 182 as described above.

Once the alternative server (e.g., central server 104g) is identified, AI model 160 may generate a recommendation 189 to copy the piece of data 124 from server 104d to the identified server 104g at the predicted time of increase in demand (e.g., last day of next quarter). Based on the recommendation 189 generated by the AI model 160, process manager 150 may copy the piece of data 124 from server 104d to the identified server 104g at the predicted time of increase in demand (e.g., last day of next quarter) and further configures central server 104g to perform report generation task. This way all requests for the piece of data 124 (e.g., report generation requests) can be processed by central server 104g. In one embodiment, process manager 150 may the piece of data 124 back to server 104d after the increased requests have been processed (e.g., on the first day of next quarter).

FIG. 2 illustrates a flowchart of an example method 200 for performing a process workflow 170 associated with a process 169, in accordance with certain embodiments of the present disclosure. Method 200 may be performed by the process manager 150 shown in FIG. 1.

At operation 202, process manager 150 receives a first latency (e.g., overall latency 174) associated with performing a process workflow 170 in a computing network 120.

At operation 204, process manager 150 inputs the first latency (e.g., overall latency 174) associated with performing the process workflow 170 to AI model 160.

As described above, process manager 150 may be configured to input a plurality of performance metrics 182 to the trained AI model 160. The performance metrics 182 input to the AI model 160 may include one or more of real-time performance metrics 182 measured for individual servers 104a-e, real-time overall latencies 174 associated with processing particular process workflows 170, or real-time task latencies 176 associated with processing individual tasks 172 by particular servers 104a-g. Additionally, or alternatively, process manager 150 may be configured to input information relating to the process workflows 170 associated with the overall latencies 174 and information relating to the tasks 172 relating to the task latencies 176.

At operation 206, process manager 150 executes the AI model 160 with the trained AI algorithm 162 to perform a plurality of operations 206A-206D.

As described above, after inputting the performance metrics 182 and other information to the AI model 160, process manager 150 may execute the AI model 160 with the trained AI algorithm 162. In one embodiment, executing the AI model 160 includes executing the trained AI algorithm 162.

At operation 206A, process manager 150 checks whether the first latency (e.g., overall latency 174) equals or exceeds a first threshold latency (e.g., threshold overall latency 178). If the first latency (e.g., overall latency 174) is lower than the first threshold latency (e.g., threshold overall latency 178), method 200 ends here. On the other hand, if the first latency (e.g., overall latency 174) equals or exceeds the first threshold latency (e.g., threshold overall latency 178), method proceeds to operation 206B.

As described above, executing the AI model 160 causes the AI model 160 to first compare the real-time overall latency 174 associated with processing a particular process workflow 170 in the computing network 120 to the threshold overall latency 178 and determine whether the real-time overall latency 174 equals or exceeds the threshold overall latency 178. Following the report generation example discussed above, the performance metrics 182 input to the AI model 160 may include a real-time overall latency 174 associated with processing a requested employee report generation in the computing network 120. The AI model 160 may determine whether the real-time overall latency 174 associated with generating the report equals or exceeds the threshold overall latency 178. In response determining that the real-time overall latency 174 associated with processing the process workflow 170 equals or exceeds the threshold overall latency 178, AI model 160 initiates the process of determining a server group 184 for processing subsequent requests for the process workflow 170 (e.g., employee report generation). As described below, the determined server group 184 includes designated servers 104a-g that perform each task 172 in the process workflow 170.

At operation 206B, process manager 150 determines, based at least on dependency matrix 168, a sequence of tasks 172 that are to be performed to complete the process workflow 170.

As described above, to determine the server group 184 associated with the process workflow 170 (e.g., employee report generation), AI model 160 first determines one or more tasks 172 that need to be performed to process the process workflow 170 and an order in which those tasks 172 are to be performed (e.g., sequence of the tasks 172) to execute the process workflow 170. In one embodiment, AI model 160 determines the sequence of tasks 172 associated with the process workflow 170 based on the dependency matrix 168. As described above, dependency matrix 168 includes information relating to tasks 172 (and corresponding servers that are configured to perform those tasks 172) that are dependent on each other. In relation to the report generation example described, AI model 160 may determine from the dependency matrix 168 that the report generation task is dependent on the approval task, the user authentication task and the verification task, the verification task is dependent on the user authentication task, and the approval task is dependent on the user authentication and verification tasks. Based on these task dependencies, AI model 160 may determine the tasks 172 needed for performing the report generation process workflow are user authentication, verification, approval and report generation. Further, AI model 160 determines that these tasks need to be performed in the order of user authentication followed by verification followed by approval and finally report generation.

At operation 206D, process manager 150, identifies a server 104a-g that can perform each task 172 of the identified sequence of tasks 172.

As described above, once the sequence of tasks 172 associated with the process workflow 170 is determined, AI model 160 determines a server 104a-g that can perform each of the identified tasks 172. In one embodiment, AI model 160 determines the servers 104a-g for performing each of the identified tasks 172 based on the relation matrix 166. As described above, the relation matrix 166 includes information relating to which server of the plurality of servers 104a-104g is capable of performing and/or configured to perform which one or more tasks 172. The relation matrix 166 may further include information relating to logical connections 122 between pairs of servers 104a-g. Based on the task-server mapping and the logical connections 122 between servers, AI model 160 may identify a server for performing each of the identified task. In relation to the report generation example, relation matrix 166 may identify that servers 104a (server-1) and 104e (server-5) are configured to perform an approval task, servers 104b (server-2) and 104f (server-6) are configured to perform a user authentication task, server 104c (server-3) is configured to perform a verification task, and server 104d (server-4) is configured to perform a report generation task. Based on these task-server mappings, AI model 160 may select server 104a for performing the approval task, server 104b for performing the user authentication task, server 104c for performing the verification task, and server 104d for performing report generation task. In one embodiment, when multiple servers are indicated as configured to perform a same task 172 in the relation matrix 166, AI model 160 may select one of the servers based on the real-time performance of the servers as indicated by the real-time performance metrics 182 associated with the servers. For example, among servers 104a and 104e configured to perform the approval task, AI model 160 may select server 104a based on detecting that server 104a has a better CPU response time as compared to server 104e.

At operation 206D, process manager 150 establishes a first group of servers (e.g., server group 184) to include the servers identified for each task 172.

As described above, once a particular server for performing each of tasks 172 is identified/selected, AI model 160 establishes a server group 184 that includes the identified servers and tasks to be performed by each of the identified servers. In relation to the report generation example, the server group 184 includes server 104a for performing the approval task, server 104b for performing the user authentication task, server 104c for performing the verification task, and server 104d for performing report generation task. In one embodiment, AI model 160 outputs the server group 184 as a result of the AI model 160.

At operation 208, once the first group of servers (e.g., server group 184) is identified, process manager 150 configures the first group of servers to perform the process workflow 170.

At operation 210, process manager 150 receives a request to perform the process workflow 170.

At operation 212, process manager 150, performs the requested process workflow 170 based on the configuration of the first group of servers (e.g., server group 184).

As described above, upon obtaining the server group 184 associated with performing the process workflow 170 (e.g., report generation) as a result of the AI model 160, process manager 150 may configure the server group 184 for executing any subsequent requests for performing the process workflow 170. In one embodiment, upon receiving a subsequent request to perform the process workflow 170, the configuration of the server group 184 causes each designated server from the server group 184 to perform the corresponding task 172. For example, after the server group 184 has been configured to perform the process workflow 170 of employee report generation, process manager 150 may receive a request 186 (e.g., user request or machine-initiated request) to perform an employee report generation. In response to receiving the request 186, process manager 150 may access the configuration of the server group 184 and initiate the execution of the process workflow 170 based on this configuration. For example, as a first step of executing the report generation workflow, process manager 150, based on the configuration, may issue a machine-initiated call 188 to server 104b to authenticate the identity of the user. Once the identity of the user is successfully authenticated, process manager 150, based on the configuration, may issue another machine-initiated call 188 to server 104c to verify authorization of the requesting user to request the report generation. Once the authorization of the user is successfully verified, process manager 150, based on the configuration, may issue another machine-initiated call 188 to server 104a to approve access of server 104d to employee records stored at the central server 104g. Upon approval, process manager 150, based on the configuration, may issue another machine-initiated call 188 to server 104d to generate the requested report.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system comprising:
a memory storing an Artificial Intelligence (AI) model that comprises an AI algorithm; and
a processor communicatively coupled to the memory and configured to:
receive a first latency associated with performing a process workflow in a computing network, wherein:
the process workflow comprises a sequence of tasks;
each task of the sequence of tasks is performed by a particular server of a plurality of servers of the computing network; and
the first latency associated with the process workflow indicates a speed of processing the process workflow;
input the first latency associated with the process workflow to the AI model, wherein:
the AI algorithm associated with the AI model is trained, based at least on a relation matrix and a dependency matrix, to determine a first group of servers for performing the process workflow;
the relation matrix comprises information relating to a task performed by each server of the plurality of servers, data stored at each server, and logical connections configured between pairs of the servers; and
the dependency matrix comprises information relating to tasks that are dependent on other tasks;
execute the AI model with the trained AI algorithm to: detect that the first latency associated with performing the process workflow equals or exceeds a first threshold latency;
in response to detecting that the first latency equals or exceeds a first threshold latency:
determine, based at least on the dependency matrix, the sequence of tasks that are to be performed to complete the process workflow, wherein the sequence of tasks comprises a first task followed by a second task;
determine, based on the relation matrix, a first server that is configured to perform the first task;
determine, based on the relation matrix, a second server that is configured to perform the second task; and
establish the first group of servers to include the first server and the second server;
configure the first group of servers to perform the process workflow, wherein the configuration of the first group of servers causes the first server to perform the first task and the second server to perform the second task;
after configuring the first group of servers, receive a first request to perform the process workflow;
in response to receiving the first request, issue a first machine-initiated call to the first server to perform the first task of the sequence of tasks in the process workflow; and
issue a second machine-initiated call to the second server to perform the second task of the sequence of tasks in the process workflow.

2. The system of claim 1, wherein the processor is further configured to:
receive a second latency associated with performing each task of the sequence of tasks by a respective server from the first group of servers;
input the second latency to the AI model;
execute the AI model with the trained AI algorithm to:
detect that the second latency associated with performing the first task of the sequence of tasks by the first server of the first group of servers equals or exceeds a second threshold latency;
in response to detecting that the second latency equals or exceeds the second threshold latency, determine that the first server has experienced an anomaly;
in response to determining that the first server has experienced an anomaly, identify based on the relation matrix a third server of the computing network that is configured to perform the first task; and
generate a second group of servers by modifying the first group of servers by replacing the first server with the third server;
configure the second group of servers to perform the process workflow, wherein the configuration of the second group of servers causes the third server to perform the first task and the second server to perform the second task;
after configuring the second group of servers, receive a second request to perform the process workflow;
in response to receiving the second request, issue a third machine-initiated call to the third server to perform the first task of the sequence of tasks in the process workflow; and
issue a fourth machine-initiated call to the second server to cause the second server to perform the second task of the sequence of tasks in the process workflow.

3. The system of claim 1, wherein the processor is further configured to:
receive a plurality of performance metrics associated with each server of the first group of servers, wherein each performance metric indicates performance of a respective server;
input the plurality of performance metrics to the AI model;
execute the AI model with the trained AI algorithm to:
determine, based on a first set of performance metrics associated with the first server of the first group of servers that is configured to perform the first task of the sequence of tasks, that the first server is overloaded;
in response to determining that the first server is overloaded, identify, based on the relation matrix, a third server of the computing network that is configured to perform the first task; and
generate a second group of servers by modifying the first group of servers by replacing the first server with the third server;
configure the second group of servers to perform the process workflow, wherein the configuration of the second group of servers causes the third server to perform the first task and the second server to perform the second task;
configure a first portion of requests for the process workflow to be performed by the first group of servers and a remaining portion of the requests for the process workflow to be performed by the second group of servers.

4. The system of claim 3, wherein the plurality of performance metrics comprise central processing unit (CPU) utilization, memory usage, disk input/output (I/O), average processing load, response time, or a combination thereof.

5. The system of claim 1, wherein the processor is further configured to:
receive information relating to historical data usage patterns;
train the AI algorithm associated with the AI model based on the historical data usage patterns;
execute the AI model with the trained AI algorithm to:
determine based on the historical data usage patterns that demand for a first piece of data is predicted to increase;
in response to the predicted increase in the demand for the first piece of data, identify, based on the relation matrix, a third server that stores the first piece of data; and
identify, based on the relation matrix, a fourth server that is accessible to the plurality of servers of the computing network and that is faster than the third server;
generate a recommendation to copy the first piece of data from the third server to the fourth server;
copy, based on the recommendation, the first piece of data from the third server to the fourth server; and
configure the fourth server to provide access to the first piece of data to servers of the computing network.

6. The system of claim 1, wherein the AI model comprises a generative AI model.

7. The system of claim 1, wherein the plurality of servers of the computing network are part of a distributed cloud environment.

8. A method comprising:
receiving a first latency associated with performing a process workflow in a computing network, wherein:
the process workflow comprises a sequence of tasks;
each task of the sequence of tasks is performed by a particular server of a plurality of servers of the computing network; and
the first latency associated with the process workflow indicates a speed of processing the process workflow;
inputting the first latency associated with the process workflow to an Artificial Intelligence (AI) model, wherein:
an AI algorithm associated with the AI model is trained, based at least on a relation matrix and a dependency matrix, to determine a first group of servers for performing the process workflow;
the relation matrix comprises information relating to a task performed by each server of the plurality of servers, data stored at each server, and logical connections configured between pairs of the servers; and
the dependency matrix comprises information relating to tasks that are dependent on other tasks;
executing the AI model with the trained AI algorithm to:
detect that the first latency associated with performing the process workflow equals or exceeds a first threshold latency;
in response to detecting that the first latency equals or exceeds a first threshold latency:
determine, based at least on the dependency matrix, the sequence of tasks that are to be performed to complete the process workflow, wherein the sequence of tasks comprises a first task followed by a second task;
determine, based on the relation matrix, a first server that is configured to perform the first task;
determine, based on the relation matrix, a second server that is configured to perform the second task; and
establish the first group of servers to include the first server and the second server;
configuring the first group of servers to perform the process workflow, wherein the configuration of the first group of servers causes the first server to perform the first task and the second server to perform the second task;
after configuring the first group of servers, receiving a first request to perform the process workflow;
in response to receiving the first request, issuing a machine-initiated first call to the first server to perform the first task of the sequence of tasks in the process workflow; and
issuing a machine-initiated second call to the second server to perform the second task of the sequence of tasks in the process workflow.

9. The method of claim 8, further comprising:
receiving a second latency associated with performing each task of the sequence of tasks by a respective server from the first group of servers;
inputting the second latency to the AI model;
executing the AI model with the trained AI algorithm to:
detect that the second latency associated with performing the first task of the sequence of tasks by the first server of the first group of servers equals or exceeds a second threshold latency;
in response to detecting that the second latency equals or exceeds the second threshold latency, determine that the first server has experienced an anomaly;
in response to determining that the first server has experienced an anomaly, identify based on the relation matrix a third server of the computing network that is configured to perform the first task; and
generate a second group of servers by modifying the first group of servers by replacing the first server with the third server;
configuring the second group of servers to perform the process workflow, wherein the configuration of the second group of servers causes the third server to perform the first task and the second server to perform the second task;
after configuring the second group of servers, receiving a second request to perform the process workflow;
in response to receiving the second request, issuing a machine-initiated third call to the third server to perform the first task of the sequence of tasks in the process workflow; and
issuing a machine-initiated fourth call to the second server to cause the second server to perform the second task of the sequence of tasks in the process workflow.

10. The method of claim 8, further comprising:
receiving a plurality of performance metrics associated with each server of the first group of servers, wherein each performance metric indicates performance of a respective server;
inputting the plurality of performance metrics to the AI model;
executing the AI model with the trained AI algorithm to:
determining, based on a first set of performance metrics associated with the first server of the first group of servers that is configured to perform the first task of the sequence of tasks, that the first server is overloaded;
in response to determining that the first server is overloaded, identifying, based on the relation matrix, a third server of the computing network that is configured to perform the first task; and
generating a second group of servers by modifying the first group of servers by replacing the first server with the third server;
configuring the second group of servers to perform the process workflow, wherein the configuration of the second group of servers causes the third server to perform the first task and the second server to perform the second task;
configuring a first portion of requests for the process workflow to be performed by the first group of servers and a remaining portion of the requests for the process workflow to be performed by the second group of servers.

11. The method of claim 10, wherein the plurality of performance metrics comprise central processing unit (CPU) utilization, memory usage, disk input/output (I/O), average processing load, response time, or a combination thereof.

12. The method of claim 8, further comprising:
receiving information relating to historical data usage patterns;
training the AI algorithm associated with the AI model based on the historical data usage patterns;
executing the AI model with the trained AI algorithm to:
determining based on the historical data usage patterns that demand for a first piece of data is predicted to increase;
in response to the predicted increase in the demand for the first piece of data, identifying, based on the relation matrix, a third server that stores the first piece of data; and
identifying, based on the relation matrix, a fourth server that is accessible to the plurality of servers of the computing network and that is faster than the third server;
generating a recommendation to copy the first piece of data from the third server to the fourth server;
copying, based on the recommendation, the first piece of data from the third server to the fourth server; and
configuring the fourth server to provide access to the first piece of data to servers of the computing network.

13. The method of claim 8, wherein the AI model comprises a generative AI model.

14. The method of claim 8, wherein the plurality of servers of the computing network are part of a distributed cloud environment.

15. A non-transitory computer-readable medium storing instructions that when executed by a processor cause the processor to:
receive a first latency associated with performing a process workflow in a computing network, wherein:
the process workflow comprises a sequence of tasks;
each task of the sequence of tasks is performed by a particular server of a plurality of servers of the computing network; and
the first latency associated with the process workflow indicates a speed of processing the process workflow;
input the first latency associated with the process workflow to an Artificial Intelligence (AI) model, wherein:
an AI algorithm associated with the AI model is trained, based at least on a relation matrix and a dependency matrix, to determine a first group of servers for performing the process workflow;
the relation matrix comprises information relating to a task performed by each server of the plurality of servers, data stored at each server, and logical connections configured between pairs of the servers; and
the dependency matrix comprises information relating to tasks that are dependent on other tasks;
execute the AI model with the trained AI algorithm to:
detect that the first latency associated with performing the process workflow equals or exceeds a first threshold latency;
in response to detecting that the first latency equals or exceeds a first threshold latency:
determine, based at least on the dependency matrix, the sequence of tasks that are to be performed to complete the process workflow, wherein the sequence of tasks comprises a first task followed by a second task;
determine, based on the relation matrix, a first server that is configured to perform the first task;
determine, based on the relation matrix, a second server that is configured to perform the second task; and
establish the first group of servers to include the first server and the second server;
configure the first group of servers to perform the process workflow, wherein the configuration of the first group of servers causes the first server to perform the first task and the second server to perform the second task;
after configuring the first group of servers, receive a first request to perform the process workflow;
in response to receiving the first request, issue a machine-initiated first call to the first server to perform the first task of the sequence of tasks in the process workflow; and
issue a machine-initiated second call to the second server to perform the second task of the sequence of tasks in the process workflow.

16. The non-transitory computer-readable medium of claim 15, wherein the instructions further cause the processor to:
receive a second latency associated with performing each task of the sequence of tasks by a respective server from the first group of servers;
input the second latency to the AI model;
execute the AI model with the trained AI algorithm to:
detect that the second latency associated with performing the first task of the sequence of tasks by the first server of the first group of servers equals or exceeds a second threshold latency;
in response to detecting that the second latency equals or exceeds the second threshold latency, determine that the first server has experienced an anomaly;
in response to determining that the first server has experienced an anomaly, identify based on the relation matrix a third server of the computing network that is configured to perform the first task; and
generate a second group of servers by modifying the first group of servers by replacing the first server with the third server;
configure the second group of servers to perform the process workflow, wherein the configuration of the second group of servers causes the third server to perform the first task and the second server to perform the second task;
after configuring the second group of servers, receive a second request to perform the process workflow;
in response to receiving the second request, issue a machine-initiated third call to the third server to perform the first task of the sequence of tasks in the process workflow; and
issue a machine-initiated fourth call to the second server to cause the second server to perform the second task of the sequence of tasks in the process workflow.

17. The non-transitory computer-readable medium of claim 15, wherein the instructions further cause the processor to:
receive a plurality of performance metrics associated with each server of the first group of servers, wherein each performance metric indicates performance of a respective server;
input the plurality of performance metrics to the AI model;
execute the AI model with the trained AI algorithm to:
determine, based on a first set of performance metrics associated with the first server of the first group of servers that is configured to perform the first task of the sequence of tasks, that the first server is overloaded;
in response to determining that the first server is overloaded, identify, based on the relation matrix, a third server of the computing network that is configured to perform the first task; and
generate a second group of servers by modifying the first group of servers by replacing the first server with the third server;
configure the second group of servers to perform the process workflow, wherein the configuration of the second group of servers causes the third server to perform the first task and the second server to perform the second task;
configure a first portion of requests for the process workflow to be performed by the first group of servers and a remaining portion of the requests for the process workflow to be performed by the second group of servers.

18. The non-transitory computer-readable medium of claim 17, wherein the plurality of performance metrics comprise central processing unit (CPU) utilization, memory usage, disk input/output (I/O), average processing load, response time, or a combination thereof.

19. The non-transitory computer-readable medium of claim 15, wherein the instructions further cause the processor to:
receive information relating to historical data usage patterns;
training the AI algorithm associated with the AI model based on the historical data usage patterns;
execute the AI model with the trained AI algorithm to:
determine based on the historical data usage patterns that demand for a first piece of data is predicted to increase;
in response to the predicted increase in the demand for the first piece of data, identify, based on the relation matrix, a third server that stores the first piece of data; and
identify, based on the relation matrix, a fourth server that is accessible to the plurality of servers of the computing network and that is faster than the third server;
generate a recommendation to copy the first piece of data from the third server to the fourth server;
copy, based on the recommendation, the first piece of data from the third server to the fourth server; and
configure the fourth server to provide access to the first piece of data to servers of the computing network.

20. The non-transitory computer-readable medium of claim 15, wherein the AI model comprises a generative AI model.
